(19) United States
(12) Patent Application Publication
(10) Pub. No.: US 2024/0047931 A1
(43) Pub. Date: Feb. 8, 2024

(54) METHOD AND DEVICE FOR HOMOGENIZING THE TEMPERATURE OF A LASER BASE PLATE

(71) Applicant: LITILIT, UAB, Vilnius (LT)

(72) Inventors: Nerijus RUSTEIKA, Vilnius (LT); Ildar GALIN, Vilnius (LT); Kestutis REGELSKIS, Vilnius (LT); Nikolajus GAVRILINAS, Vilnius (LT)

(21) Appl. No.: 18/257,523

(22) PCT Filed: Dec. 10, 2022
(86) PCT No.: PCT/IB2021/061557

§ 371 Date: Jun. 14, 2023

(30) Foreign Application Priority Data
Dec. 14, 2020 (LT) LT2020563

(51) Int. Cl. H01S 3/04; H01S 3/02

(52) U.S. Cl. CPC H01S 3/0405; H01S 3/025; H01S 3/0407

(57) ABSTRACT

The invention relates to the field of laser technology, and methods and devices intended for homogenizing the temperature of a laser base plate, where optical component holders are attached to the laser base plate comprising a heat transfer medium. In order to reduce susceptibility of the laser base plate to local temperature differences, ensuring stable positions of the optical components and, consequently, the orientation of the optical paths, the material from which the laser base plate and optical component holders are made is stainless steel. Heat pipes are built into the laser base plate and have a significantly higher thermal conductivity than stainless steel, and their coefficient of thermal expansion is close to the coefficient of thermal expansion of stainless steel. The holders of the optical components are attached and adjusted with respect to each other to said laser base plate by laser spot welding.

### TECHNICAL FIELD TO WHICH INVENTION RELATES

The invention relates to the field of laser technology, more particularly to methods and devices for homogenizing the temperature of a laser base plate.

### RELEVANT PRIOR ART

Typically, the laser base plate or laser body and optical component holders are made of aluminum alloys because aluminum has good thermal conductivity (approximately 230 W/K/m), is easy to process mechanically, has strength and low weight, and aluminum is a relatively inexpensive metal. However, aluminum also has drawbacks: aluminum parts tend to distort due to residual stresses after the mechanical treatment and natural aging, which makes it difficult to ensure constant positions of the laser optical components and to maintain a stable orientation of the optical paths, and aluminum welding is a complex process and optomechanical assemblies such as mirrors, lenses, optical fiber splitters, polarizers, etc. holders, are usually fastened to the laser base plate with screws or glued, which results in undesired stresses, which can also lead to misalignment of the optical components. Also, in order to ensure constant positions of the optical components and stable directivity of the optical paths as the laser temperature changes and temperature gradients arise, the laser base plate and optical component holders are made of alloys with ultra-low temperature expansion properties such as invar or kovar. There are also attempts to make laser base plates from SiO2 (silicon dioxide).

There is a known stabilized laser device which is weakly dependent on temperature changes and which consists of a laser medium, a resonator and a resonator-supporting housing made of SiO2 or invar, which have a very low coefficient of thermal expansion. A known laser device is described in Japanese Patent Application JPS5645091 (A), 1981.

The disadvantage of the known laser device is that it is technologically difficult to fabricate a larger-sized laser base plate from invar and SiO2 and weld optomechanical assemblies to it. In addition, SiO2 and invar are relatively poor thermal conductors and unsuitable for heat dissipation from heat emitting laser components. Also, SiO2 and invar are expensive materials compared to aluminum alloys or stainless steel.

There is a known laser resonator whose input and output mirrors are mounted on a base made of an invar alloy, and a laser crystal and nonlinear optical crystals are arranged between the mirrors, and a heat exchanger is mounted between the nonlinear optical crystal and the base to maintain the intended nonlinear optical crystal temperature. A known laser resonator is described in Japanese Patent Application JPH0895104 (A), 1996.

The disadvantage of the known device is that the invar alloy from which the base of the device is made is a poor thermal conductor compared to aluminum and it is not suitable for heat dissipation from intensely heating laser elements. In addition, invar alloys are expensive compared to aluminum alloys or stainless steel.

There is a known solid state laser stacked from the rear by a diode laser or an array of diode lasers whose components are mounted on a low temperature expansion base plate which is thermally stabilized by a thermoelectric cooler. The laser includes a heat sink, a thermoelectric cooler mounted on the heat sink, a base plate mounted on the thermoelectric cooler, and diode lasers and optical elements mounted on the base plate. The optical system is adapted to operate at a certain temperature at which the wavelength of the diode laser is matched to the absorption band of the active medium. The thermistor measures the temperature of the base plate and by adjusting the current of the thermoelectric cooler, a constant operating temperature of the base plate is maintained regardless of the ambient temperature. The known laser is described in U.S. Pat. No. 5,181,214 (A), 1993.

The disadvantage of the known laser is that the application of this method to stabilize the temperature of a large laser base plate is complicated and expensive, requires a large number of thermoelectric coolers and a large amount of electricity to power the thermoelectric components, and due to the large amount of heat released in the thermoelectric coolers, additional means of heat dissipation must be provided. In addition, in the vertical direction, from the top of the base to the bottom to which the thermoelectric cooler is mounted, large temperature gradients occur and as a result the base plate can bend, especially if the temperature expansion coefficient of the base plate is not negligibly low.

There is a known method and device for attaching optical components to an optical stand, wherein the optical component is mounted on a vertical portion of the optical holder and the vertical portion of the holder is attached to the base plate of the holder. The base plate of the holder includes a heater, such as a resistive heater, which is used to solder the main plate of the holder to the optical stand. In order to reposition the optical component mounting holder after it is already soldered to the optical stand, the heater is turned on until the solder melts, then the position of the holder is changed and the heater is turned off. The known method and device for attaching optical components to an optical stand is described in U.S. Pat. No. 6,292,499 (B1), 2001.

A disadvantage of the known method and device is that the mounting holders for the optical components are adjusted after heating and melting the solder, as a result, a large area of the optical stand is exposed to temperature, as well as the holder becomes hot, and the position of the optical components may change due to temperature changes and resulting stresses as the solder cools and solidifies. In addition, during the transfer of a solder from a liquid to a solid state, the position of the optical components may change and the directions of the optical paths may change accordingly.

There is a known thermal control device and method for a thin disk laser system that allows near-isothermal temperatures to be reached through the entire thin disk laser crystal or ceramic by means of a mechanically controlled oscillating heat pipe with an effective thermal conductivity of 10-20,000 W/m/K, the coefficients of thermal expansion of the thin disk laser crystal or ceramic and the supporting structure are matched. A known thermal control device and method for a thin disk laser system is described in International Patent Application WO2011091381A2, 2011.

A disadvantage of the known method and device is that while the problem of high power thin disk laser crystal or ceramic mount is solved by eliminating temperature gradients and correspondingly eliminating thin disk deformation, it does not solve the problem of attaching the optical components to the laser base plate and stabilizing the position of the optical components.

A liquid cooling system for an optical stand and a method for ensuring the thermal stability of an optical stand are known. The optical stand is cooled by a liquid in an optical stand circulating in a network of channels, and the optical stand can be cooled by a cold plate, and in some cases, the liquid additionally cools the optical components that emit a large amount of heat. In this way, proper control of the liquid flows in the channel network ensures cooling of the optical stand and even temperature distribution. The known system and method for cooling an optical stand with liquid is described in U.S. Patent Application US2020161825 (A1).

A disadvantage of the known system and method for stabilizing the temperature of an optical stand with a flowing liquid is that a liquid is used for cooling and special sealing measures must be taken to prevent the liquid from penetrating the system. In addition, a chiller is required for cooling and pumping the liquid for cooling and temperature stabilization. Liquid cooling of the optical stand also requires additional maintenance and service, which is an additional cost and time.

There is a known laser diode assembly whose housing and mounting part has a main body formed from copper and has sheathing composed of steel. As a result, it is possible to achieve a mounting area composed of the steel, while the thermal conductivity improved by the copper can be obtained at the same time.

A disadvantage of the known device is that while the thermal conductivity of laser diode assembly housing is improved, this does not solve the problem of deformation of laser base plate and misalignment of the position of the optical elements relative to each other as the laser temperature changes and temperature gradients arise. A known laser diode assembly is described in U.S. Patent Application US20140092931A1, 2014.

There is a known water-cooled breadboard which is equipped with two parallel copper tubes through which water flows.

The disadvantage of the known breadboard is that the heat removal from the board requires water flowing through the copper tubes and therefore the equipment must be provided with a chiller. In addition, the water flowing through the copper tubes is cooler than the breadboard, thus creating a temperature gradient that bends the breadboard. A known water cooled breadboard is described in document Base Lab Tools: “October 2015 Newsletter—Liquid cooled breadboard”, 25 Oct. 2015 (2015-10-25), pages 1-4, XP55836026, Retrieved from the Internet: URL: https://www.baselabtools.com/October-2015-Newsletter_b_22.html [retrieved on 2021-08-30]

### Technical Problem to be Solved

The invention is intended to increase the resistance of the laser base plate to local temperature differences, ensuring stable positioning of the optical components and, accordingly, directivity of the optical paths, to suppress the temperature gradients formed in the laser base plate due to the heat emitted by the laser components and to reduce the resulting protrusions of the laser base plate accordingly, to reduce the warm-up time of the laser when the laser is turned on, ensure the resistance of the laser base plate and optical component holders to natural aging, increasing the reliability and service life of the laser, also to simplify the construction of the mechanical part of the laser, to reduce the costs of laser production, to simplify the procedures of laser assembly and adjustment and to adapt the laser to mass production.

### Disclosure of the Essence of the Invention

The essence of the invention is disclosed in the proposed method and device for homogenizing the temperature of a laser base plate according to the claims.

### Advantages of the Invention

An advantage of the present invention is that the laser base plate and the optical component holders are made of stainless steel with excellent mechanical properties but poor thermal conductivity, so that the laser base plate incorporates passive heat transfer means (“passive heat transfer means” refer to heat pipes that employs phase transition to transfer heat or copper rods) which significantly improve the thermal conductivity of the laser base plate and reduce the temperature gradients in the laser base plate due to the heat emitted by some optical components, such as the laser amplification medium, which significantly reduces the deformation of the laser base plate and correspondingly reduces the misalignment of the optical components and the misalignment of the optical paths.

Stainless steel has excellent machining properties, can be milled, turned, is easily arc-welded and laser-welded, has low residual deformations after mechanical treatment, has high corrosion resistance, has resistance to natural aging, and due to the above-mentioned properties, even after many years, the laser base plate is not distorted, the holders of the optical components are not distorted, the laser is not distorted and the laser parameters are not changed. However, stainless steel has a sufficiently low thermal conductivity (15-18 W/K/m) compared to aluminum (236 W/m/K), and in accordance with the invention, in order to improve the thermal conductivity of a laser base plate made of stainless steel, passive heat transfer means, particularly heat pipes, are provided for effectively improving the thermal conductivity of the laser base plates arranged in the laser base plate, preferably symmetrically and evenly spaced. The passive heat transfer means may be heat pipes or copper rods inserted in holes milled in the laser base plate. Copper has an extremely high thermal conductivity (400 W/K/m) and a sufficiently well-matched coefficient of thermal expansion with the coefficient of thermal expansion of stainless steel. The total thermal conductivity of the laser base plate depends on the filling density of the copper rods in the stainless steel laser base plate. For example, if the volume of evenly spaced copper rods occupies half the volume of the laser base plate, then the thermal conductivity of such composite laser base plates is close to that of aluminum. By improving the overall thermal conductivity of the laser base plate in this way, the mechanical properties of the laser base plate change insignificantly and are as good as those of stainless steel.

In addition, due to the improved thermal conductivity of the laser base plate, the insertion of passive heat transfer means, preferably heat pipes significantly shortens the warm-up time of the laser, and the operating temperature distribution of the laser settles much faster after the laser is switched on.

The heat pipes in the stainless steel laser base plate can be arranged and oriented selectively in any direction, such as across the laser base plate, and depending on the orientation direction of the passive heat transfer means, heat will be best transferred in the same direction. Also in the same laser base plate, the heat pipes can be oriented in several directions, for example oriented according to the length, width and thickness of the laser base plate, in which case the heat pipes form two-dimensional or three-dimensional gratings.

Also, the heat pipes may be metal heat pipes, in which the phase transformation of the liquid is used for heat transfer, heat is transferred from the warmer part of the pipe by evaporating the liquid and condensing the steam in the colder place of the pipe. The effective thermal conductivity of heat pipes can reach 100 kW/K/m, while the thermal conductivity of copper is about kW/K/m.

The thermal contact between the passive heat transfer means and the laser base plate is improved by using a thermal paste, soft solder or indium.

Moreover, in order to improve the thermal properties of the laser base plate, the ends of the heat pipes on the outside of the laser base plate can be additionally connected to the additional passive heat transfer means, such as heat pipes, thus distributing the temperature more evenly.

The laser base plate is cooled by attaching heat sinks to the laser base plate and passive heat transfer means, such as heat pipes; the heat sinks can be cooled by air or water. Also, in order to improve the laser cooling, cooling channels through which the coolant, such as water, flows may additionally be provided in the laser base plate.

Another advantage of using stainless steel is that the holders of the optical components, which are also made of stainless steel, are fastened to the laser base plate using laser spot welding. Laser spot welding has a small zone of thermal impact, as a result, the holders of the optical components do not come off during welding. This method of fastening, compared to fastening with screws, gluing or soldering, is characterized by extremely high accuracy, resistance to temperature changes, extremely low residual stresses, which ensures stable position of optical components and stable directional direction of optical paths with changing laser temperature.

In addition, the holders of the optical components can be monolithic, made of stainless steel and aligned in the plane of the laser base plate according to two orthogonal translating coordinates and one rotating coordinate. Also, the optical component holders can be composite, consisting of two monolithic blocks arranged in perpendicular planes, the optical component holders are attached to the laser base plate and the composite optical component holders are assembled using laser spot welding.

Moreover, passive heat transfer means, preferably heat pipes may also be incorporated into the optical component holders to further improve thermal performance.

In addition, laser spot welded optical component holders can be aligned very precisely with the same welding laser by directing the laser pulses to the appropriate locations of the welding or optical component holders.

Furthermore, attaching the optical component holders to the laser base plate using laser spot welding is ideal for automated laser assembly and mass production.

Also, laser spot welding is a technologically clean way of fastening optomechanical assemblies compared to gluing or soldering technologies.

Another advantage is that stainless steel has significantly lower degassing compared to aluminum alloys, which is especially important in lasers generating higher optical harmonics in the UV spectral region; the vapors emitted from the laser base plate and the mechanical units are deposited on the surfaces of nonlinear crystals under the influence of UV radiation and their properties deteriorate until they are finally optically damaged.

The invention is explained in detail by drawings, which do not limit the scope of the invention and which show the following:

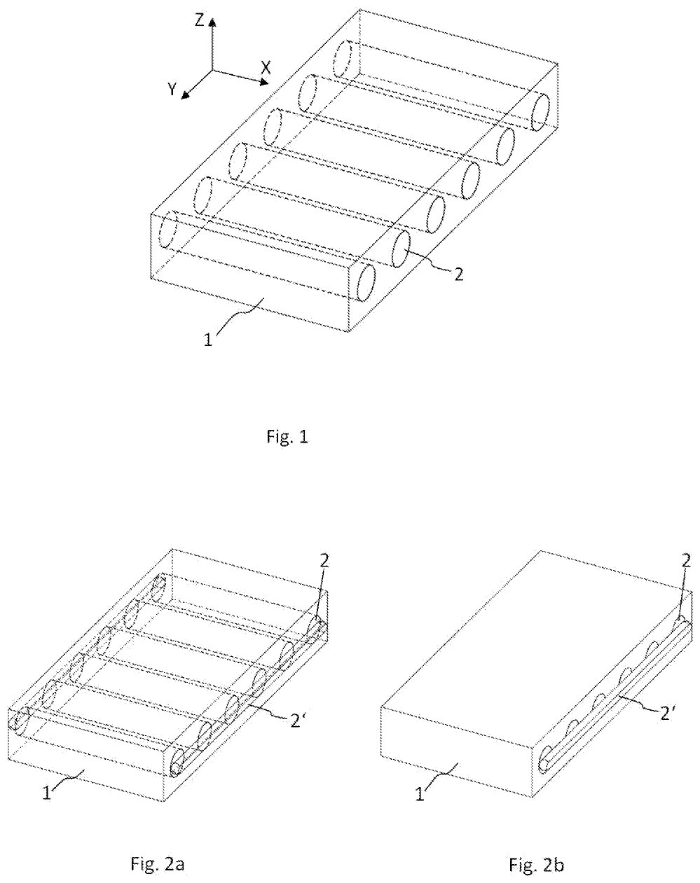

FIG. 1 shows a laser base plate with elongated heat pipes or copper rods inserted in an array of holes milled in the laser base plate, an axonometric projection with a semi-transparent image is presented.

FIG. 2a shows a laser base plate with elongated heat pipes or copper rods inserted in an array of holes milled in the laser base plate, which are connected to other heat pipes at the edges of the laser base plate, an axonometric projection with a semi-transparent view is presented.

FIG. 2b shows a laser base plate with elongated heat pipes or copper rods inserted in an array of holes milled in the laser base plate, which are connected to other heat pipes at the edges of the laser base plate, an axonometric projection is presented, but with an opaque view.

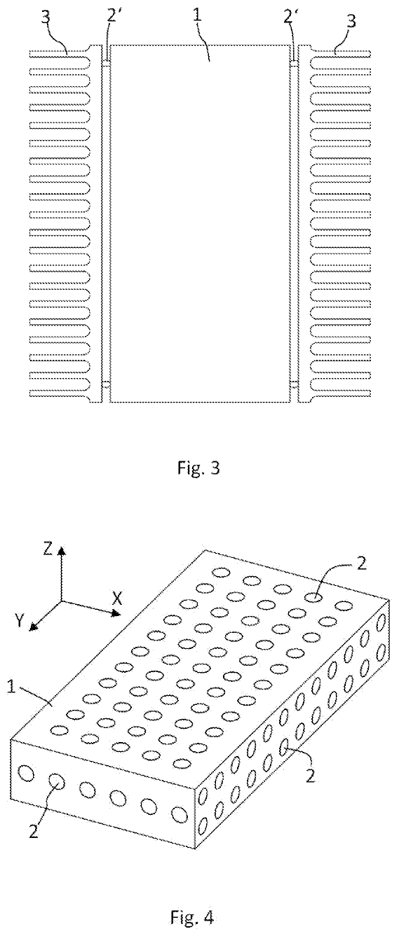

FIG. 3 shows a top view of a laser base plate with elongated heat pipes inserted in an array of holes milled in the laser base plate and cooling heat sinks mounted on its sides.

FIG. 4 shows a laser base plate in which elongated heat pipes are inserted along all directions- (length, width and height), axonometric projection is presented.

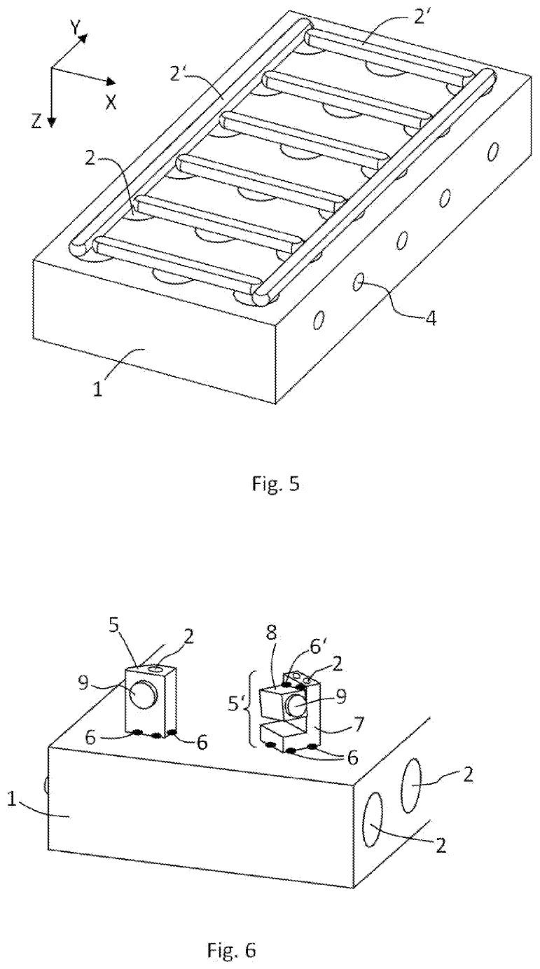

FIG. 5 shows a view of a laser base plate in which elongated heat pipes are inserted through the Z-axis and these heat pipes are interconnected with other heat pipes at the bottom of the laser base plate, and in the direction of the X axis, the cooling channels through which the coolant flows are formed, view from below.

FIG. 6 shows the holders of optical components, one holder is monolithic, the other—composite, and which are attached to the laser base plate using laser spot welding, the axonometric projection is presented and only a fragment of the laser base plate is shown.

### EXAMPLES OF REALIZATION OF THE INVENTION

The method of stabilizing the position of the optical components and the orientation of the optical paths involves selecting the material of the optical component holders and the laser base plate, in this case, the selected stainless steel has excellent mechanical and laser spot welding properties, and the thermal conductivity of the laser base plate is increased and at the same time the temperature gradients are suppressed by inserting prolongated, passive heat transfer means (“passive heat transfer means” refer to heat pipes that employs phase transition to transfer heat or copper rods) into the laser base plate. The invention essentially enables the laser base plate and optical component holders to be made of stainless steel, providing thermal properties close to and even better than aluminum alloys, as well as the use of stainless steel enables the mounting and alignment of the optical component holders to the laser base plate using laser spot welding.

FIG. 1 shows a laser base plate 1 in which elongated heat pipes 2 are arranged at regular intervals at equal intervals from each other in the direction of the X axis resulting in a significant increase in the total thermal conductivity in the X direction, in the case shown, across the laser base plate 1. In the simplest case, the passive heat transfer means 2 can be threaded rods made of pure copper which are screwed into the holes milled in the laser base plate 1, and the coefficients of thermal expansion of copper and stainless steel are very similar, so that no harmful stresses occur with temperature. And for even greater thermal conductivity, the heat pipes 2 can be selected from a wide range of commercially available heat pipes that employs phase transition to transfer heat. It is desirable that the coefficients of thermal expansion of the heat pipes 2 be similar to the coefficient of thermal expansion of stainless steel.

FIG. 2a and FIG. 2b show a laser base plate 1 in which the inserted heat pipes or copper rods 2 on the outside of the laser base plate are connected to other heat pipes 2′, thus improving the thermal conductivity not only transversely but also along the laser base plate 1. FIG. 2a shows a semi-transparent laser base plate, and FIG. 2b shows the laser base plate which is not transparent.

FIG. 3 shows a laser base plate 1 with heat sinks 3 mounted on its sides for dissipating excess heat to the environment, the heat sinks 3 being connected to heat pipes 2′, which in turn are connected to heat pipes or copper rods 2 inserted in the laser base plate 1 (FIG. 3 does not show the heat pipes or copper rods 2), view from above. The heat sinks 3 can be cooled with both air and water, as well as in the laser base plate 1, in order to dissipate excess heat, channels 4 can be formed in which the coolant flows.

FIG. 4 shows a laser base plate 1 in which heat pipes 2 are arranged in the X, Y and Z directions, preferably at equal intervals, thus effectively increasing the thermal conductivity in all directions. Heat pipes arranged at different falls may overlap. Also, the heat pipes 2 can be additionally connected to the additional heat pipes on the outside of the laser base plate, thus further improving the thermal properties of the laser base plate.

FIG. 5 shows a laser base plate 1 in which the heat pipes 2 arranged in the Z direction at the bottom of the laser base are interconnected by means of additional heat pipes 2′, thus effectively improving the thermal conductivity of the laser base plate not only in the Z direction but also in the X and Y directions. Alternatively, cooling channels 4 can be formed in the laser base plate 1, through which the coolant, preferably water, flows and carries away the excess heat in the laser. The cooling channels 4 can be formed at any point of the laser base plate 1, oriented in any direction and can be of any shape. In the figure, the laser base plate 1 is shown from bottom.

FIG. 6 shows monolithic and composite optical component holders 5 and 5′, which are attached to the laser base plate 1 by means of laser spot welding 6. The monolithic optical component holder 5 consists of a solid piece of stainless steel and is aligned with the transverse plane of the laser base plate 1 and one angular coordinate. The composite optical component holder 5′ consists of two interconnected stainless steel blocks 7 and 8 by means of laser spot welding 6′, the composite optical component holder 5′ has all three degrees of transverse adjustment freedom and two degrees of angular adjustment freedom. The optical components 9 are spring-loaded or glued or pressed to the optical component holders 5, 5′. The advantage of said holders of optical components 5, 5′ is that they do not have adjustable screws in their construction and are fastened to the laser base plate by means of laser spot welding. Heat pipes 2 can also be additionally inserted in the optical component holders 5, 5′. The optical components 9 are, for example, mirrors, lenses, polarizers, phase plates, crystals, collimators, beam splitters and the like.

When copper rods are inserted in an array of holes milled in the laser base plate, the temperature of the laser base plate stabilizes much faster when the heater is switched on. Thus, by inserting heat pipes into the laser base plate, not only does the laser base plate protrude less, but the operating temperature of the laser stabilizes much faster when it is turned on.

The stainless steel laser base plate with inserted heat pipes and the stainless steel optical component holders are an excellent solution for the mechanical part of the laser, ensuring the stability of the position of the optical components relative to each other.

1. A method for homogenizing the temperature of a laser base plate, wherein holders of laser optical components are attached to the laser base plate, comprising steps of:
choosing of material from which the laser base plate (1) and laser optical component holders (5, 5′) will be made;
providing the laser base plate (1) with elongated heat pipes (2) inserted into an array of holes made in the laser base plate (1); and
attaching the laser optical component holders (5, 5′) to the laser base plate (1) and adjusting the laser optical component holders (5, 5′) with respect to each other using laser spot welding to their final alignment;
wherein the material selected for the production of the laser base plate (1) and the laser optical component holders (5, 5′) is stainless steel;
wherein the elongated heat pipes (2) are selected to have a significantly, preferably at least ten times, a higher thermal conductivity than stainless steel and a coefficient of thermal expansion close to that of stainless steel.

2. The method according to claim 1, wherein the elongated heat pipes (2) are made of a metal having good thermal conductivity such as copper, and more preferably pure copper.

3. (canceled)

4. The method according to claim 1, wherein the elongate heat pipes (2) which are inserted into the laser base plate (1) are heat pipes of a selected diameter and length that employs phase transition to transfer heat.

5. The method according to claim 4, wherein the heat pipes are arranged in one or more different directions with respect to the laser base plate (1).

6. The method according to claim 1, wherein the laser optical component holders (5) are monolithic and prior to mounting to the laser base plate, the laser optical component holders are aligned in a plane of the laser base plate according to two orthogonal translation coordinates and one rotating coordinate, after which the laser optical component holders are mounted using laser spot welding, and after mounting, the final alignment is performed using laser spot welding.

7. The method according to claim 1, wherein the laser optical component holders (5′) are composite, consisting of two monolithic blocks (7) and (8) which are assembled and aligned with each other in a plane perpendicular to a plane of the laser base plate (1), and fastened by laser spot welding (6′), and the assembled laser optical component holder (5′) is aligned in the plane of the laser base plate and fastened to the laser base plate (1) by laser spot welding (6), or first the laser base plate (1) is aligned and fastened to the lower block (7) using laser spot welding (6), and then aligns and fastens the upper block (8) to the lower block (7) using laser spot welding (6′).

8. A device for homogenizing the temperature of the laser base plate, wherein laser optical component holders for laser optical components are attached to the laser base plate, comprising:
elongated heat pipes for homogenizing the temperature of the laser base plate, wherein the laser base plate (1) and the laser optical component holders (5, 5′) are made of stainless steel, and the elongated heat pipes are (2) inserted in an array of holes made in the laser base plate (1), where the thermal conductivity of the elongated heat pipes (2) are significantly, preferably not less ten times, higher than the thermal conductivity of stainless steel and coefficient of thermal expansion is close to that of stainless steel, wherein at least two laser optical component holders (5, 5′) are attached to the laser base plate (1) and finally adjusted with respect to each other by laser spot welding (6).

9. The device according to claim 8, wherein the elongated heat pipes (2) are made of a metal having good thermal conductivity, such as copper, and more preferably pure copper.

10. (canceled)

11. The device according to claim 8, wherein the elongated heat pipes (2) which are inserted into the laser base plate (1) are heat pipes of a selected diameter and length, that employs phase transition to transfer heat.

12. The device according to claim 8, wherein the elongated heat pipes (2) are arranged in one or more different directions with respect to the laser base plate (1).

13. The device according to claim 12, wherein the elongated heat pipes (2) are inserted in the holes made in the laser base plate (1), arranged in one direction at equal intervals from each other.

14. The device according to claim 12, wherein the elongated heat pipes (2) are inserted into the holes made in the laser base plate (1), and are arranged without intersecting in different directions.

15. The device according to claim 8, wherein ends of the elongated heat pipes (2) are connected to an outside of the laser base plate (1) by additional elongated heat pipes (2′).

16. The device according to claim 8, further comprising heat sinks (3) for dissipating excess heat arranged on an outside of the laser base plate (1) on its sides and on the elongated heat pipes (2, 2′).

17. The device according to claim 8, wherein the laser optical component holders (5, 5′) of the optical components have embedded elongated heat pipes (2).

18. The device according to claim 8, wherein in the laser base plate (1) are channels (4) of a selected shape and direction additionally formed for dissipating excess heat, in which coolant flows.

19. The device according to claim 8, wherein the laser base plate (1) and the laser optical component holders (5, 5′) are made of AISI 304 stainless steel.

20. The device according to claim 14, wherein the elongated heat pipes are further arranged according to width and/or length and/or height of the laser base plate (1).

21. The device according to claim 18, wherein the coolant is water.
